(19) United States
(12) Patent Application Publication
(10) Pub. No.: US 2019/0307050 A1
(43) Pub. Date: Oct. 10, 2019

(54) HARROW SPRING TINE, ATTACHMENT THEREFOR AND METHOD OF MAKING SAME

(71) Applicant: China Pacificarbide, Inc., Chino, CA (US)

(72) Inventors: Jeff Tyler Rhode, Anaheim Hills, CA (US); Corey Alan Johnson, Bismarck, ND (US)

(21) Appl. No.: 16/374,808

(22) Filed: Apr. 4, 2019

Related U.S. Application Data
(60) Provisional application No. 62/653,953, filed on Apr. 6, 2018.

(51) Int. Cl. A01B 23/02; A01B 23/00; B23K 1/002

(52) U.S. Cl. CPC A01B 23/02; B23K 1/002; A01B 23/00

(57) ABSTRACT

A harrow spring tine having a tine shaft that carries a distinct, separately formed cutting edge member body, formed of a hardened material such as tungsten carbide and/or a material having a longer wear life relative to material of the tine shaft and brazed directly to the tine shaft, to provide optimum durability and wear resistance on an area of the tine shaft extending a short distance upward from the bottom end of the tine shaft, where the most ground contact will occur during use of the tine.

### CROSS-REFERENCE TO RELATED APPLICATIONS

This application claims priority to U.S. Provisional Application No. 62/653,953 filed Apr. 6, 2018, entitled “ATTACHMENT FOR HARROW SPRING TINE,” the contents of which are hereby incorporated by reference in their entirety.

### FIELD

The present disclosure relates to the field of harrow tines. The present disclosure more specifically relates to the field of attachments for providing a hardened edge and/or extended wear life at the lower end of a harrow spring tine shaft.

### BACKGROUND

Harrows have been in use for years. A spring harrow is an implement featuring a frame that is towed over the ground (e.g., by an agricultural tractor) so that a set of spring tines depending downward from the frame engage the ground surface to agitate it, break it up and/or smooth it out, sometimes with residual crop material. A typical spring harrow includes a double coil spring tine, where a pair of horizontally spaced apart coils wind around a generally shared horizontal axis with inner ends of the coils joined together by a central cross-bar running parallel to that axis. A tine shaft extends downwardly from the outer end of each of the two coils. The coil spring is assembled to a shaft that is mounted to the implement frame. Single coil tines are sometimes also used, where each tine features only a single coil spring and single respective downward tine shaft.

A known problem with typical spring tines is that they tend to wear relatively quickly, and accordingly require frequent replacement. They also wear unevenly such that some tines are shorter than others and the tines cannot optimally achieve downward pressure and/or hold residual crop material.

U.S. Pat. No. 9,282,687 of Arksey et al. attempts to address this issue by mounting a multi-piece cutting edge attachment to a circular shaft of a harrow tine. The multi-piece attachment features a mounting member formed of a material that is weldable to, and distinct from, a first material of the harrow tine. The multi-piece attachment also includes a cutting edge member formed of a third material that is harder than the first and second materials and less weldable to a harrow tine than the second material of the mounting member. The cutting edge member has a front face and an opposing rear face that is conformingly shaped for placement against a front face of the mounting member at a lower end thereof. According to Arksey et al., the multi-piece arrangement forms a cutting edge of greater hardness than that which is achievable by a material directly attachable to the tine itself.

According to Arksey et al., U.S. Pat. No. 6,425,446 of Gates also attempts to address this issue by mounting a one-piece hardened edge member to a front side of each tine shaft at the lower end thereof to increase the effective hardness at the leading side of the lower portion of the resulting tine structure. The member is made of chrome to provide greater hardness than the spring tine material, while being suitable for attachment to the spring tine by welding.

### SUMMARY

While the Gates solution does provide a cutting edge of improved durability relative to the tine itself, there remains room for improvement, as use of more durable materials than chrome, such as tungsten carbide, would further improve the wear life of the tine, but known challenges of attaching to the tine a more durable material such as a tungsten carbide wear piece have prevented and discouraged the use of such material as it is not suitable for welded attachment to the spring tine. While the Arksey et al. solution provides for a cutting edge using more durable materials than chrome, known ways of attaching to the tine a more durable material such as a tungsten carbide wear piece have prevented and discouraged the use of such material as it is not suitable for welded attachment to the spring tine, and instead requires that use of a multi-piece attachment.

There is a need for a solution that allows for the attachment of more durable materials such as tungsten carbide directly to the tine. Accordingly, an improved spring tine cutting edge member or attachment and method for making and mounting same are provided.

Accordingly, the present disclosure provides a spring tine comprising: a tine shaft, the tine shaft having a lower end having a front side with a convex peripheral surface; and a cutting edge member having a back side, the back side being arcuately curved in a concave manner to conform with the convex peripheral surface of the front side of the tine shaft; whereby the back side of the cutting edge member is brazed to the convex peripheral surface of the front side of the tine shaft.

Accordingly, the present disclosure provides a harrow spring tine comprising: a tine having a diameter and a lower end, whereby the lower end has a leading face; and a hardened attachment brazed to the leading face of the lower end of the tine; whereby the hardened attachment has opposing edges or sides defining a width equal to or exceeding the diameter of the tine, or sufficient to protect the tine.

Accordingly, the present disclosure provides cutting edge member for a spring tine, the cutting edge member comprising: a cutting edge member body the cutting edge member body having an arcuately curved backside configured to conform with a convex peripheral surface of a shaft of a spring tine for brazing to the convex peripheral surface of the shaft of the spring tine, symmetric rear side walls flaring laterally outward to increase a width of cutting edge member relative to its back side, and symmetric front side walls that are curved.

### BRIEF DESCRIPTION OF DRAWINGS

Various examples of embodiments of the systems, devices, and methods according to this invention will be described in detail, with reference to the following figures, wherein:

FIG. 1 illustrates a perspective view of a double spring tine which includes a cutting edge attachment coupled thereto, according to various examples of embodiments;

FIG. 2 illustrates a detailed perspective view of a spring tine of the double spring tine and cutting edge attachment illustrated in FIG. 1;

FIG. 3 illustrates a horizontal cross-sectional view of the spring tine and cutting edge attachment illustrated in FIG. 2;

FIG. 4 illustrates a front view cutting edge attachment illustrated in FIG. 3;

FIG. 5 illustrates a horizontal cross-sectional view of a spring tine and a cutting edge attachment attached thereto, according to another example embodiment;

FIG. 6 illustrates a front view of the cutting edge attachment illustrated in FIG. 5;

FIG. 7 illustrates a horizontal cross-sectional view of a spring tine and a cutting edge attachment attached thereto, according to another example embodiment;

FIG. 8 illustrates a front view of the cutting edge attachment illustrated in FIG. 7;

FIG. 9 illustrates a horizontal cross-sectional view of a spring tine and a cutting edge attachment attached thereto, according to another example embodiment;

FIG. 10 illustrates a front view of the cutting edge attachment illustrated in FIG. 9;

FIG. 11 illustrates a horizontal cross-sectional view of a spring tine and a cutting edge attachment attached thereto, according to another example embodiment;

FIG. 12 illustrates a front view of the cutting edge attachment illustrated in FIG. 11;

FIG. 13 illustrates a horizontal cross-sectional view of a spring tine and a cutting edge attachment attached thereto, according to another example embodiment;

FIG. 14 illustrates a front view of the cutting edge attachment illustrated in FIG. 13;

FIG. 15 illustrates a horizontal cross-sectional view of a spring tine and a cutting edge attachment attached thereto, according to another example embodiment;

FIG. 16 illustrates a front view of the cutting edge attachment illustrated in FIG. 15;

FIG. 17 illustrates a horizontal cross-sectional view of a spring tine and a cutting edge attachment attached thereto, according to another example embodiment;

FIG. 18 illustrates a front view of the cutting edge attachment illustrated in FIG. 17;

FIG. 19 illustrates a horizontal cross-sectional view of a spring tine and a cutting edge attachment attached thereto, according to another example embodiment;

FIG. 20 illustrates a front view of the cutting edge attachment illustrated in FIG. 19; and

FIG. 21 illustrates a flow diagram for securing, attaching or coupling a cutting edge attachment to a spring tine, according to various examples of embodiments.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

Referring to the Figures, a harrow spring tine, cutting edge attachment attached thereto, and method for making same, are provided.

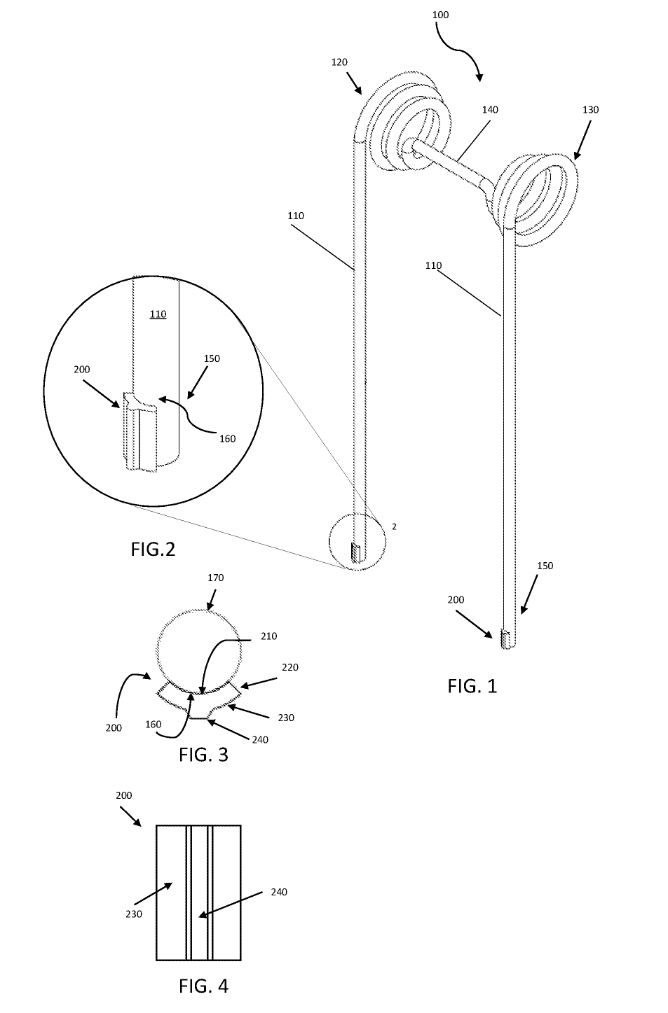

FIG. 1 illustrates a double coil spring tine load provided with an example embodiment of a cutting edge attachment. As illustrated, a spring tine 100 includes one or more shafts 110 depending downward from outer ends of a pair of coaxial coils 120/130 that are horizontally spaced apart from one another along a shared horizontal axis by a central cross-bar 140. Referring now to FIGS. 1 and 2, spring tine 100 includes a working or cutting edge member 200 provided on a lower end 150 of tine shaft 110 to increase the wear life and/or hardness of a front or leading side 160 of shaft 110 that engages in the ground during use of tine 100.

More particularly, the illustrated embodiment utilizes one or more working or cutting edge members 200 attached, mounted or secured at an exposed position to front or leading side 160 of shaft 110 of spring tine 100 to provide improved durability and longer wear life at lower end 150 of tine shaft 110.

With reference to FIGS. 3-4, an example embodiment of working or cutting edge member 200 is illustrated. In various embodiments, working or cutting edge member 200 includes a back side 210. In various embodiments, backside 210 of cutting edge member 200 is arcuately curved in a concave manner to conform with a convex peripheral surface of circular-section tine shaft 110 on front side 160 of shaft 110 that leads an opposing rear side 170 when tine 100 is conveyed (e.g., along the ground) by a harrow or other implement on which tine 100 is provided. In various embodiments, cutting edge member 200 is linear in length, which runs parallel to a longitudinal axis of linear shaft 110 of tine 100. In various embodiments, the arcuate curve in backside 210 of cutting edge member 200 is uniform over the length of cutting edge member 1000.

In various embodiments, such as that illustrated in FIG. 3, concave backside 210 of cutting edge member 200 spans less than one hundred eighty degrees (180°) so that cutting edge member 200 does not fully span a diameter of tine shaft 110 (e.g., at its conforming interface against front side 160 of shaft 110).

However, in other examples of embodiments, such as that illustrated in FIG. 5, a cutting edge member 300 defines or includes a concave backside 310 that spans up to or more than one hundred eighty degrees (180°) so that cutting edge member 300 fully spans at least a diameter, or half a circumference, of tine shaft 110 (e.g., at its conforming interface against front side 160 of shaft 110.

Referring again to FIG. 3, moving forwardly away from concave backside 210 placed against tine shaft 110, cutting edge member 200 includes one or more rear side walls 220. In various embodiments, rear side walls 220 flare laterally outward to increase a width of cutting edge member 200 relative to its backside 210, interface or point of contact with shaft 110. In various embodiments, rear side walls 220 are flat and are symmetric to one another across a central longitudinal plane that contains the longitudinal axis of tine shaft 110 and cuts radially through an apex of concave backside 210 of cutting edge member 200.

In various embodiments, cutting edge member 200 includes one or more front side walls 230 that are curved and symmetric about the central longitudinal plane, and converge forwardly from rear side walls 220, providing a forwardly annular, curved or convex shape.

In various embodiments, the curvature of front side wall(s) 230 is symmetric with the curvature of rear side wall 220. However, it should be appreciated that the front side wall may have a different curvature than the rear side wall.

In various embodiments, cutting edge member 200 also includes a ridge, thickened cross-sectional area or dimension, or other feature 240 extending longitudinally along front wall 230 (e.g., in center of first wall 230) or at or about convergence of one or more front side walls 230.

FIGS. 5-12 illustrate various embodiments of other cutting edge members 300/400/500/600. As illustrated in FIGS. 5-12, in various examples of embodiments, cutting edge member 300/400/500/600 includes various examples of features 340/440/540/640.

Referring now to FIGS. 13-14, another embodiment of a cutting edge member 700 is illustrated. As illustrated, in various embodiments, cutting edge member 700 includes a single front side wall 730. In various embodiments, cutting edge member 700 does not include a ridge, thickened cross-sectional area or dimension, or other feature extending longitudinally along front wall 730.

Referring now to FIGS. 15-20, various example embodiments of cutting edge members 800/900/1000 having one or more front side walls 830/930/1030 and one or more rear side walls 810/910/1010 are illustrated. In various examples of embodiments, cutting edge members 800/900/1000 include one or more transition side walls 850/950/1050, and front side walls 830/930/1030 extend forwardly from transition side walls 850/950/1050 extending between front side wall 830/930/1030 and rear side walls 810/910/1010. In various examples of embodiments, front side walls converge to form a leading edge 860/960/1060. In various embodiments, however, the one or more front side walls are curved and symmetric about the central longitudinal plane, and converge forwardly from transition side walls extending between the rear side walls and the front side walls, providing a forwardly curved shape (e.g., as illustrated in FIGS. 9-12).

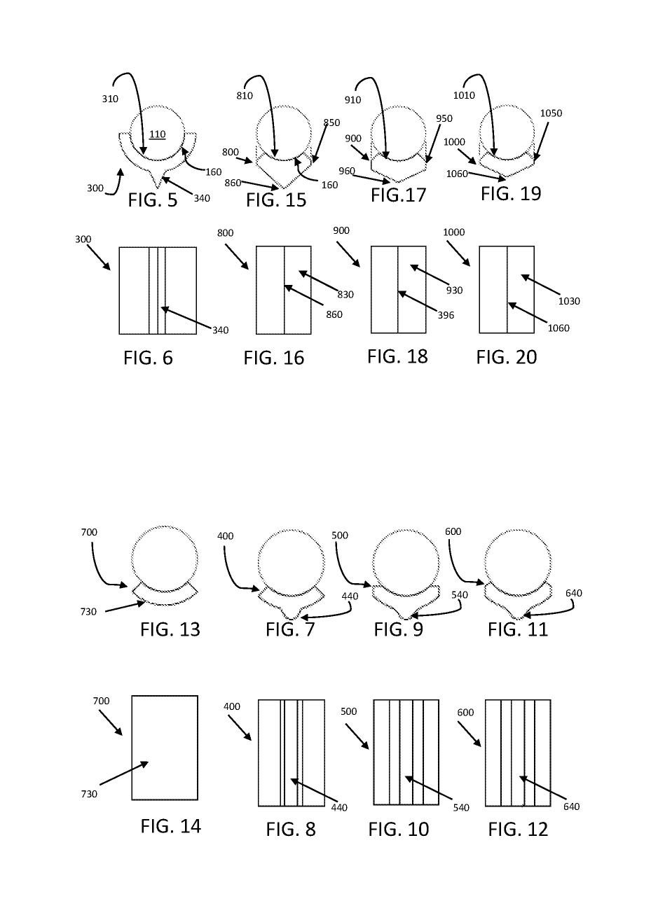

Referring back again to FIGS. 3-4, at a widest point of cutting edge member 200, e.g., in a plane containing two parallel edges at which the front side walls 220 and rear side walls 230 (or transition side walls (not shown in FIGS. 3-4)) meet on the opposite sides of cutting edge member 200, cutting edge member 200 has a width equal to or slightly exceeding the diameter of tine shaft 110 and/or sufficient to help protect the tine, thus presenting a full width shield over front or leading side 160 or a forward facing half of a circumference of shaft 110 for optimum protection thereof by the harder and rear resistant cutting edge member 200. However, it should be appreciated that the widest point of the cutting edge member may have a width less that the diameter of the tine shaft, or as shown in FIGS. 5-6, more than the diameter of tine shaft 110.

In various examples of embodiments, the rear side walls have radiuses and symmetrically curve outwardly and, moving forwardly, back inward to converge into one or more front side walls. In various embodiments, only one cutting edge member may be used on a single tine. It should be appreciated, however, the multiple cutting edge members may be utilized.

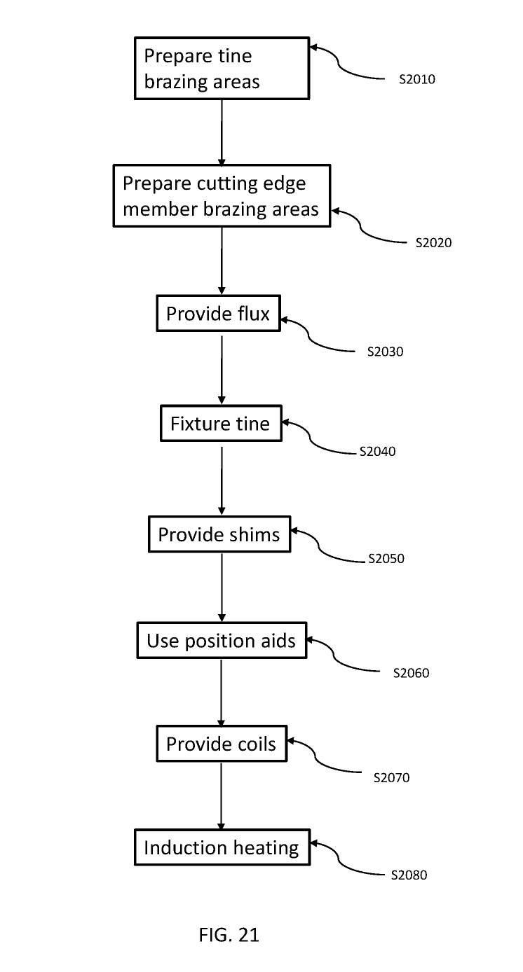

In various embodiments, the cutting edge member is secured, mounted, attached, coupled or otherwise provided on the tine shaft by brazing. An example brazing process is illustrated in FIG. 21. In various embodiments, in Step S2010, one or more tine brazing areas are provided and/or prepared. In various examples of embodiments, one or more tine brazing areas are prepared by removing all or substantially all dirt, grease and residues from one or more brazing areas or surfaces on the tine. In Step S2020, in various embodiments, one or more cutting edge member brazing areas are provided and/or prepared. In various examples of embodiments, one or more cutting edge member brazing areas are prepared by removing all or substantially all dirt, grease and other residues from one or more brazing areas on the concave backside of the cutting edge member. Dirt, grease, and other residues may be removed using known methods including grinding, application of solvents or other substances, etc.

In various embodiments, in Step S2030, flux is provided on the one or more brazing areas of the concave backside of the cutting edge member and/or the one or more brazing areas of the tine shaft. In various embodiments, in Step S2040, the tine is fixtured.

In various embodiments, in Step S2050, alloy brazing shims are cut to the shape of a braze joint. In various examples of embodiments, the alloy brazing shims are provided between the tine and the cutting edge member (e.g., in a desired position).

In Step S2060, fixtures to aid in positioning shims and/or tiles relative to the tine and/or cutting edge member may be used depending on shape and location requirements. Optionally, steel mesh may be added above or below alloy braze shim.

In various embodiments, in Step S2070, induction coils are provided and/or positioned around the tine with the cutting edge member provided relative to the tine as desired.

In various examples of embodiments, in Step S2080, induction heating is applied to the tine and cutting edge member. In various embodiments, when a specified, pre-determined or optimal temperature for braze alloy is reached, the cutting edge member is seated into position with a rod or fixture. In various embodiments, the brazed areas are insulated to slow the cooling of those areas following brazing.

In various embodiments, the tine carries a distinct, separately formed body of tungsten carbide to provide optimum durability and wear resistance at a location rising a short distance upward from the bottom end of the tine shaft, where the most ground contact will occur during use of the tine.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

What is claimed is:

1. A spring tine comprising:
a tine shaft, the tine shaft having a lower end having a front side with a convex peripheral surface; and
a cutting edge member having a back side, the back side being arcuately curved in a concave manner to conform with the convex peripheral surface of the front side of the tine shaft;
whereby the back side of the cutting edge member is secured the convex peripheral surface of the front side of the tine shaft by brazing.

2. The spring tine of claim 1, whereby the cutting edge member is made of a hardened material.

3. The spring tine of claim 2, whereby the cutting edge member is made primarily of tungsten carbide.

4. The spring time of claim 3, whereby the cutting edge member comprises one or more rear side walls.

5. The spring tine of claim 4, whereby the one or more rear side walls flare laterally outward to increase a width of cutting edge member relative to its back side.

6. The spring tine of claim 5, whereby the rear side walls are flat and symmetric to one another across a central longitudinal plane that contains a longitudinal axis of tine shaft and cuts radially through an apex of the concave backside of cutting edge member.

7. The spring tine of claim 6, whereby the cutting edge member comprises one or more front side walls that are curved and symmetric about the central longitudinal plane.

8. The spring time of claim 7, whereby the one or more front side walls converge forwardly from the rear side walls to define a forwardly annular, curved or convex shape.

9. The spring tine of claim 7, whereby the one of more front side walls are symmetric with the back side of the cutting edge member.

10. The cutting edge member of claim 8, whereby the cutting edge member further comprises a ridge extending longitudinally along the cutting edge member at or about a convergence of the front side walls.

11. A harrow spring tine comprising:
a tine having a diameter and a lower end, whereby the lower end has a leading face; and
a hardened attachment brazed to the leading face of the lower end of the tine;
whereby the hardened attachment has opposing edges or sides defining a width equal to or exceeding the diameter of the tine.

12. The harrow spring tine of claim 11, whereby the hardened attachment is made primarily of tungsten carbide.

13. The harrow spring tine of claim 12, whereby the leading face of the tine has a convex peripheral surface and whereby the hardened attachment has a back side arcuately curved in a concave manner to conform to the convex peripheral surface of the front side of the leading face of the tine.

14. A cutting edge member for a spring tine, the cutting edge member comprising:
a cutting edge member body the cutting edge member body having an arcuately curved backside configured to conform with a convex peripheral surface of a shaft of a spring tine for brazing to the convex peripheral surface of the shaft of the spring tine, symmetric rear side walls flaring laterally outward to increase a width of cutting edge member relative to its back side, and symmetric front side walls that are curved.

15. The cutting edge member of claim 14, whereby the front side walls converge forwardly from the rear side walls to define a forwardly annular, curved or convex shape.

16. The cutting edge member of claim 15, whereby the front side walls are curved.

17. The cutting edge member of claim 15, whereby the front side walls are flat.

18. The cutting edge member of claim 16, whereby the front side walls converge forwardly from the rear side walls to define a forwardly annular, curved or convex shape.

19. The cutting edge member of claim 17, whereby the front side walls converge forwardly from the rear side walls to define a forwardly angled shape.

20. The cutting edge member of claim 15, whereby the cutting edge member further comprises a ridge extending longitudinally along at or about a convergence of the front side walls.
